(19) United States
(12) Patent Application Publication
(10) Pub. No.: US 2025/0045685 A1
(43) Pub. Date: Feb. 6, 2025

(54) SYSTEM AND METHOD FOR TRACKING THE MOVEMENT OF ANIMALS

(71) Applicant: GlobalVetLink, L.C., Ames, IA (US)

(72) Inventors: Stephen James Adamson, Des Moines, IA (US); Stacey Lee Noe, Huxley, IA (US); Kristy Shiota, San Francicso, CA (US)

(73) Assignee: GlobalVetLink, L.C., Ames, IA (US)

(21) Appl. No.: 18/787,534

(22) Filed: Jul. 29, 2024

Related U.S. Application Data
(60) Provisional application No. 63/516,790, filed on Jul. 31, 2023.

(51) Int. Cl. G06Q 10/0833; A01K 29/00; G06Q 50/02

(52) U.S. Cl. CPC G06Q 10/0833; A01K 29/00; G06Q 50/02

(57) ABSTRACT

A system for a system for a computer program product is provided that includes a non-transitory computer readable storage medium comprising computer executable code to obtain at least one of driver data or vehicle data and determine that a vehicle is at a first pickup location. The executable code can also be configured to obtain animal data related to the first pickup location, determine that the vehicle is at a first drop off location, obtain additional animal data related to the first drop off location, dynamically adjust the animal data to form adjusted animal data based on the additional animal data obtained, and record in a memory the adjusted animal data.

### CROSS-REFERENCE

This application is claims priority to and the benefit of U.S. Provisional Application No. 63/516,790, filed Jul. 31, 2023.

### BACKGROUND

Embodiments herein generally relate to systems and methods for transporting animals, and more particularly the tracking of animals.

Animals such as livestock are often transferred to numerous locations. In particular, livestock such as swine, cattle, bovine, horses, boars, turkeys, chickens, or the like can be bred in an initial location, and then transported to a different location to be raised. When providing the transportation, a vehicle driver goes from farm to farm picking up the animals or livestock, and then the livestock is taken to a delivery location. After such delivery of all the animals, the vehicle is cleaned such that the driver can repeat this action.

Currently, there is not a way to track such animal movements in real time. As a result, when a foreign disease outbreak (FDO) occurs, such as the swine flu, it can take days to gather all of the relevant animal movement information to determine how large of an area to lock down and to potentially perform contact tracing.

For example, if at a swine raising facility a swine is diagnosed with swine flu, all swine at that facility must be euthanized. Then, a communication needs to be made to all vehicle drives who brought swine to the facility on the day that the infected swine arrived. Then, all swine from all facilities that provided swine for delivery on that day must also euthanize their swine. In addition, any other swine from that facility that had been transported by any other vehicles must also be tracked down in a similar manner. This occurs for every breeder associated with the delivery truck regardless of when pickups occurred, or whether any swine from a particular breeder are exposed to the infected swine. Consequently, the lock down area and number of swine that need to be euthanized can become extremely large very quickly. This not only is time consuming, but exceptionally expensive.

In addition, artificial intelligence (AI) is becoming common place for use in association with electronic devices. Whether to assist in making choices for an individual while shopping, customizing use, or just recognizing different individuals, AI is becoming more prominent in day-to-day settings. AI applications include AI algorithms that attempt to utilize numerous variables based on information received to make determinations regarding choices that are to be made. The AI algorithms utilize initial assumptions to determine the variables, and as individuals make choices, the variables are modified to reflect an individual's choice.

Thus, a need in the art exists for better tracking and tracing of animal such as livestock for transportation.

### SUMMARY

In accordance with embodiments herein, a system for a computer program product is provided that includes a non-transitory computer readable storage medium comprising computer executable code to obtain at least one of driver data or vehicle data and determine that a vehicle is at a first pickup location. The executable code can also be configured to obtain animal data related to the first pickup location, determine that the vehicle is at a first drop off location, obtain additional animal data related to the first drop off location, dynamically adjust the animal data to form adjusted animal data based on the additional animal data obtained, and record in a memory the adjusted animal data.

Optionally, the computer program product also can include executable code to communicate the adjusted animal data to a remote electronic device in response to a request by the remote electronic device for the adjusted animal data. In one aspect, to obtain the at least one of the driver data or the vehicle data, the executable code can communicate a prompt on an input screen of an electronic device for the driver data or the vehicle data. In another aspect, to obtain the at least one of the driver data or the vehicle data, the executable code can automatically load a profile of a driver of a vehicle. In one example, to determine that the vehicle is at the first pickup, the executable code can obtain location data from a sensor of the vehicle. In another example, to determine that the vehicle is at the first pickup, the executable code may obtain location data from a manual input of a driver.

Optionally, the computer program product may also include executable code to continuously monitor a location of the vehicle in response to determining the first pickup location, and to determine a second pickup location based on monitoring the location of the vehicle. In one aspect to determine the second pickup location may comprise utilizing an artificial intelligence application. In another aspect, in response to determining the second pickup location, the executable code can obtain additional animal data; and dynamically adjust the animal data based on the additional animal data. In one example, additional executable code can determine no animals remain in the vehicle after determining the vehicle is at the first pickup location and may obtain cleaning data related to the vehicle in response to determining that no animals remain in the vehicle. In another example to obtain the cleaning data the executable code may prompt a driver to enter wash data related to the vehicle. In yet another example the executable code may record the wash data in the memory.

In accordance with embodiments herein, a system for tracking animals can be provided that includes an electronic device having a memory to store executable instructions and one or more processors. When implementing the executable instructions the one or more processors can be configured to obtain at least one of driver data or vehicle data, determine that a vehicle is at a first pickup location, obtain animal data related to the first pickup location, determine that the vehicle is at a first drop off location, obtain additional animal data related to the first drop off location, dynamically adjust the animal data to form adjusted animal data based on the additional animal data obtained, and record in a memory the adjusted animal data.

Optionally the electronic device can include a sensor configured to obtain location data of the electronic device, and the one or more processors further configured to determine the first pickup location based on the location data. In one aspect, the electronic device may include an input screen, and the one or more processors can be further configured to display a prompt for the animal data in response to determining the vehicle is at the first pickup location. In another aspect, the one or more processors can be further configured to continuously monitor a location of the vehicle in response to determining the first pickup location and determine a second pickup location based on monitoring the location of the vehicle. In one example to determine the second pickup location can include utilizing an artificial intelligence application. In another example, in response to determining the second pickup location, the one or more processors can be further configured to obtain additional animal data, and dynamically adjust the animal data based on the additional animal data.

In accordance with embodiments herein a method for tracking animals can be provide that includes, under control of one or more processors, including program instructions to obtain at least one of driver data or vehicle data and determine that a vehicle is at a first pickup location. The program instructions may also be configured to obtain animal data related to the first pickup location, determine that the vehicle is at a first drop off location, obtain additional animal data related to the first drop off location, dynamically adjust the animal data to form adjusted animal data based on the additional animal data obtained, and record in a memory the adjusted animal data. Optionally, the one or more processors can be further configured to continuously monitor a location of the vehicle in response to determining the first pickup location and determine a second pickup location based on monitoring the location of the vehicle.

### BRIEF DESCRIPTION OF THE DRAWINGS

FIG. 1 illustrates a schematic block diagram of a system for tracking animals, in accordance with embodiments herein.

FIG. 2A illustrates an example input screen of an electronic device, in accordance with embodiments herein.

FIG. 2B illustrates an example input screen of an electronic device, in accordance with embodiments herein.

FIG. 3 illustrates an example input screen of an electronic device, in accordance with embodiments herein.

FIG. 4 illustrates an example input screen of an electronic device, in accordance with embodiments herein.

FIG. 5 illustrates an example input screen of an electronic device, in accordance with embodiments herein.

FIG. 6 illustrates an example input screen of an electronic device, in accordance with embodiments herein.

FIG. 7 illustrates an example input screen of an electronic device, in accordance with embodiments herein.

FIG. 8 illustrates a schematic block diagram of an electronic device in accordance with embodiments herein.

FIG. 9 illustrates a schematic flow block diagram of a method of tracking animals in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

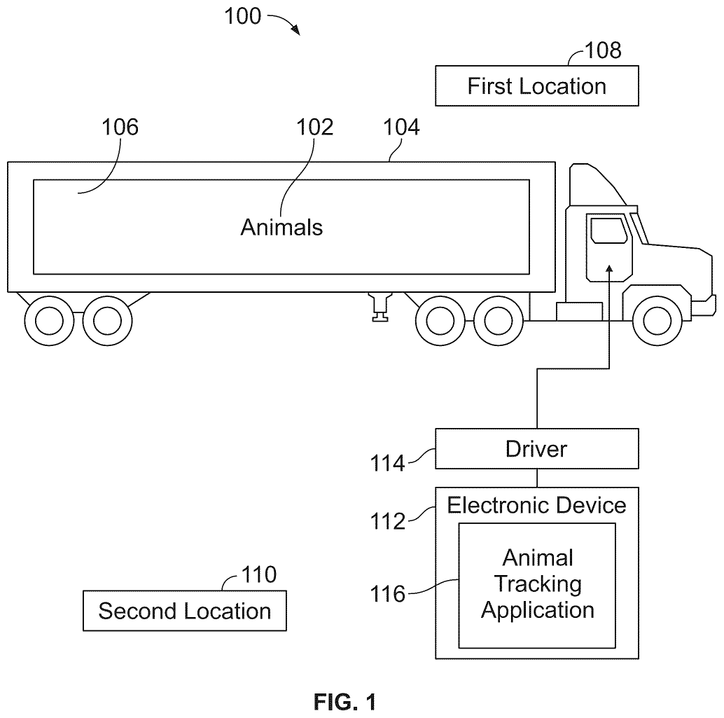

FIG. 1 Illustrates a tracking system 100 for determining the location of animals 102. The animal can be livestock, swine, bovine, avian, equine, or the like that are transported as a group by a vehicle 104 that includes housing 106 for the individual animals. The vehicle 104 can be any vehicle, including a truck, automobile, train, tractor trailer, airplane, etc. that is able to transport the animal from a first location 108 to a second location 110. In one example, the first location 108 is the facility of a breeder whereas the second location 110 is a facility where the animal is raised.

The tracking system 100 also includes at least one electronic device 112. The electronic device 112 in example embodiments can be a smart phone, iPad, iPod, laptop computer, or the like. The electronic device 112 can be a portable device that is associated with the driver 114 of the vehicle 104. The electronic device 112 may be associated with the driver 114 as a result of the driver 114 owning the electronic device, the driver 114 having the electronic device 112 provided by an employer, the driver 114 using the electronic device 112 of another, or the like. The electronic device 112 can include an animal tracking application 116 that functions to track when one or more animals 102 are loaded onto the vehicle 104, when additional animals 102 are loaded onto the vehicle 104, when animals 102 are unloaded from the vehicle, when the vehicle is washed, when the vehicle is cleaned, or the like.

The animal tracking application 116 can include executable code that can be stored in a memory (FIG. 10) of the electronic device 112 and executed by one or more processors (FIG. 10) of the electronic device 112 to obtain the animal transfer data. In one example, when receiving the animal tracking application 116, the driver 114, employer of the driver, etc. can input driver data such as the driver's name, employer, vehicle description, license plate number, route information, or the like to identify the driver 114 of the vehicle. The driver can also input drive data such as when the driver washes or sterilizes the vehicle.

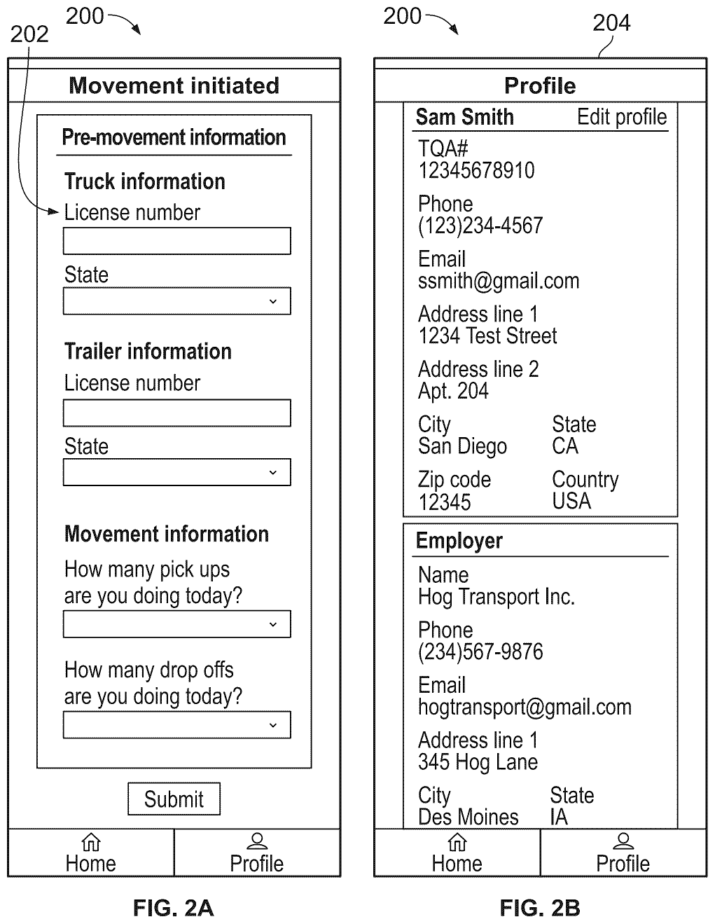

FIGS. 2A-2B illustrate example input screens 200 that may be generated by the animal tracking application to obtain driver data and animal tracking data when the driver begins using the animal tracking application 116. As illustrated, the input screen 200 can include numerous prompts 202 where driver data can be inputted by the driver 114 using an input device such as a keyboard, microphone, or the like. The prompt 202 can include the terms or words that request the information, along with the box or space provided on the input screens 200 where input can be provided. Such information can include data related to the truck, such as the truck license number, state of the license plate, number of pickups and/or drop-offs during a day, whether a trip will go across state lines, or the like. Such data and information can be provided before pickups begin so that the driver does not have to provide such information while attempting to transport the animals. The prompts 202 are reminders for the driver 114 regarding the information that is desired for tracking purposes. In one example, a driver 114 may have a driver profile 204 that includes driver and vehicle information that is already populated so that only information such as the amount of pickups and drop-offs is required to be entered by the driver.

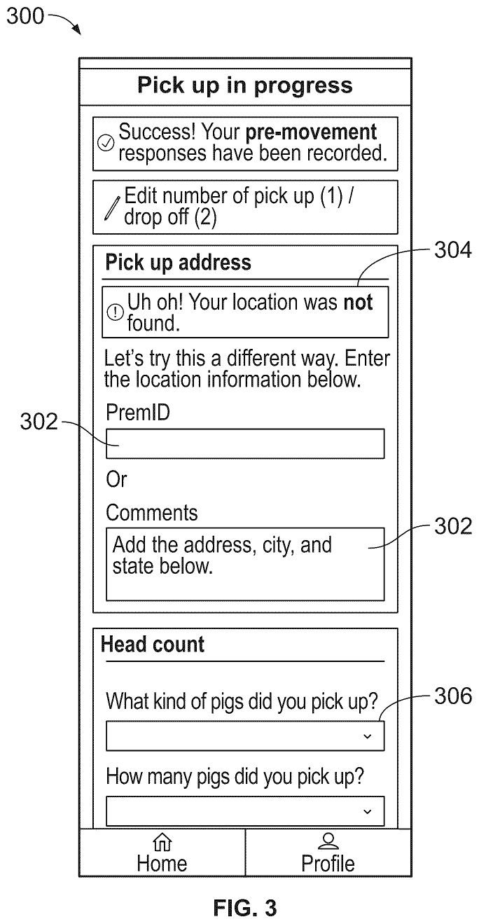

With reference back to FIG. 1, the tracking application 116 may also obtain animal data for any and all animals loaded or unloaded from the vehicle. For example, the electronic device may include a sensor (FIG. 10) that allows for geofencing of the driver 114 such that when the driver is at a first breeder facility, an automatic output, such as a prompt, can be communicated to the driver 114 to input information related to the animals being loaded. FIG. 3 illustrates an example input screen 300 that can be communicated or loaded for review by the driver 114 when the sensor indicates the driver is at a determined location such as a pickup location, or an unloading location. In the example, when the sensor is a global navigation system (e.g., global positioning system), location data 304 such as the address of the location can be automatically identified by the tracking application and populated onto the input screen 300.

In this example embodiment, the input screen 300 can include a prompt 302 to have the driver input the address. To this end, in certain instances, a GPS signal may not be available, or an address unknown. Still, the tracking application 116 can utilize one or more other sensors, communications etc. to identify when a vehicle has stopped for a determined period such as at least two minutes, been turned off, or the like that suggests loading of animals may be occurring. Alternatively, after receiving driver and vehicle data (e.g., after input screens of 2A-2B), the input screen can automatically switch, or change to a manual input screen as illustrated in FIG. 3. In this manner, the driver 114 understands that once a pickup location is reached, the driver 114 should manually input information prompted on the input screen 300 such as address of pickup location, number of animals loaded, time of pickup, or the like. To this end, in addition to location data 304 animal data 306 can also be inputted into the input screen 300 by the driver 114. For example, the number of animals being loaded can be provided. Other animal data such as type of animal, last feeding, loading time, or the like can also be provided. The animal tracking application 116 can include other prompts 302 based on the type of animal, or desires of customers. For example, when swine are transported, only a head count may be requested, whereas when horses are transported, head count, and feeding schedule may be desired. In addition, in one embodiment, an employer may provide the inputs desired to provide custom prompts.

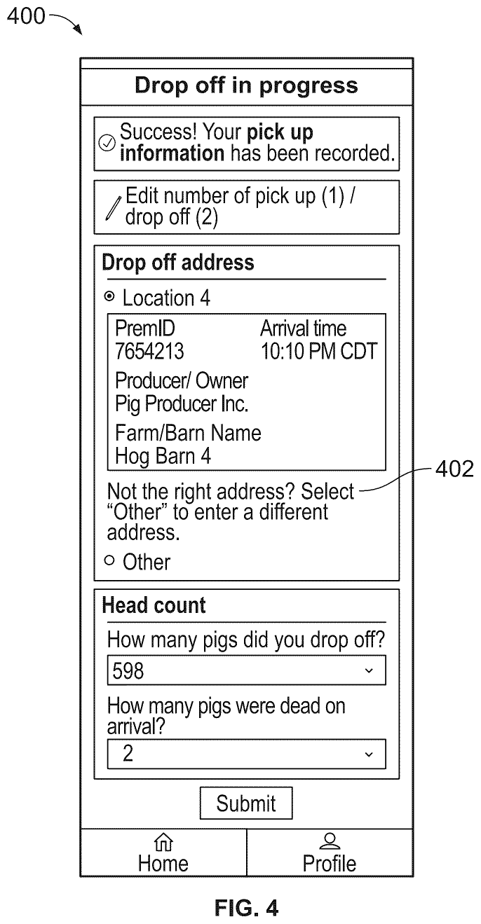

FIG. 4 illustrates an additional input screens 400 for various situations that a driver 114 may experience while utilizing the tracking application 116. As can be seen, multiple prompts 402 can be provided for drop off, including address, and number of animals dropped off at a location. To this end, the ability to edit information can be provided so that if the driver when reviewing information realizes they mistyped in a license plate number, animal count, misspelled an address, or the like, the driver 114 can go back to edit the information to provide additional accuracy.

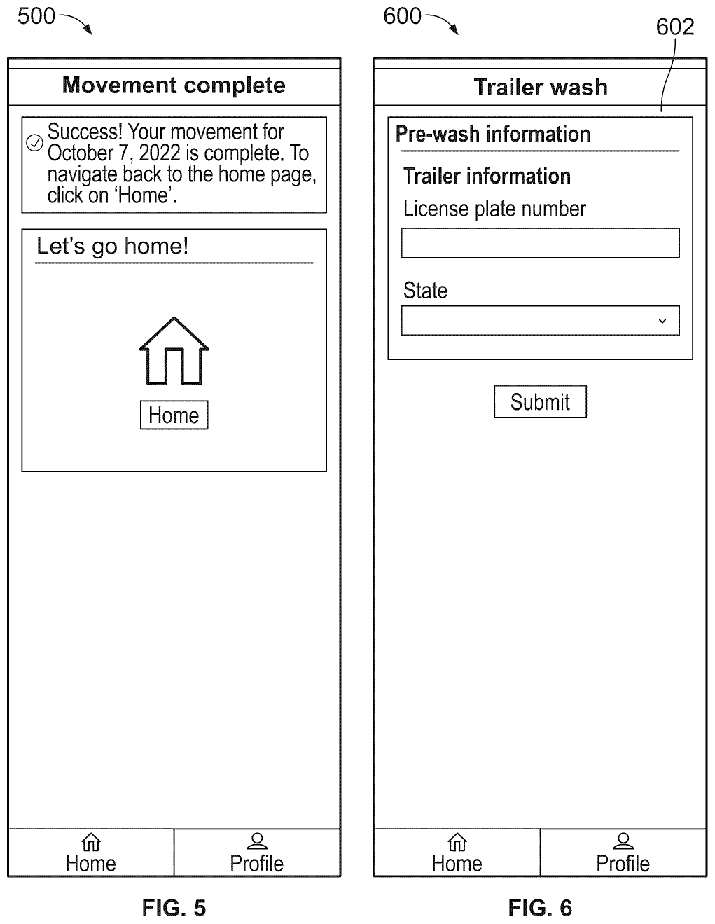

Once all animals are loaded, transported and delivered, an input screen 500 as provided in FIG. 5 can be communicated by the animal tracking application 116. Still, the animal tracking application 116 can continue to track additional data, including sanitation information such as when a vehicle is cleaned. FIG. 6 illustrates an input screen 600 that track when a vehicle is washed, including prompts 602 for the address where washing has occurred, type of wash that has occurred, or the like. Similar to previous input screens, information can be input automatically by the animal tracking application 116 via communication with a sensor, such as a GPS sensor, or can be manually input by a driver 114. Regarding the washing information, when an animal is shown to have contracted a sickness, such as a flu, by washing the vehicle out, the germs can be removed from the vehicle. As a result, future animals transported by the vehicle are safe from contamination such that after an outbreak is discovered, animals transported by a vehicle after a washing do not have to be euthanized. In addition to washing, the tracking application may include other inputs that can be similarly utilized, such as exposing the vehicle to the sun for an extended period, exposing the vehicle to UV light, or light that may be shown to kill or eliminate germs and/or disease.

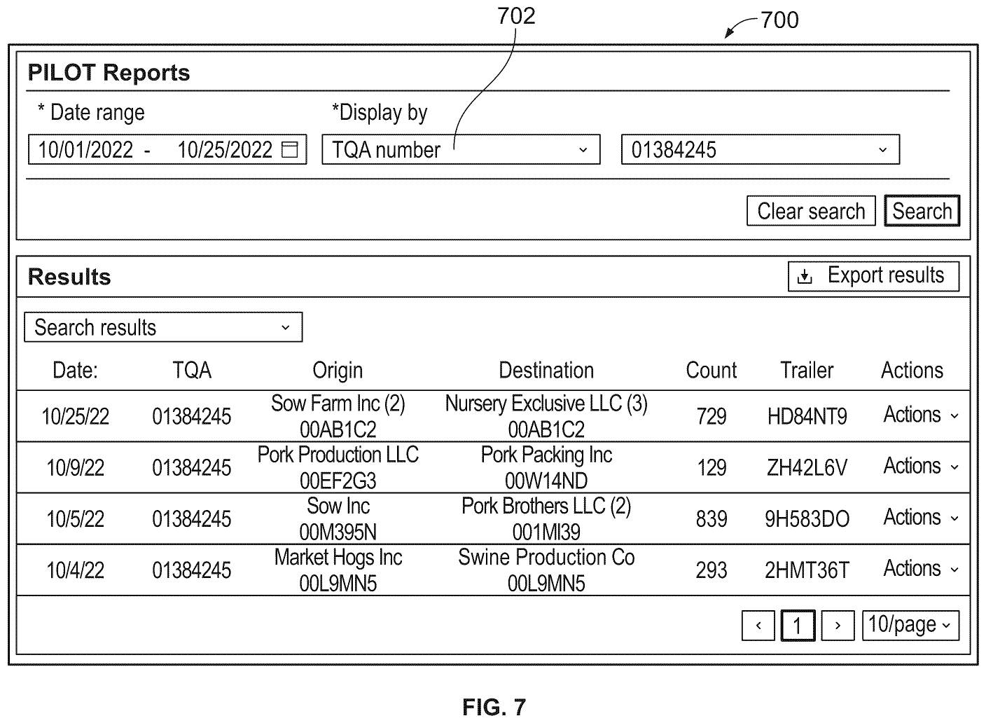

FIG. 7 illustrates an additional input screen 700 that can be generated by the animal tracking application 116. Such input screen 700 include tools 702 for obtaining reports related to the information input by a driver 114. These tools can include ways to correlate or present driver data, vehicle data, animal data, or the like for viewing by a driver, employer, customer, etc. In addition, the driver, employer, customer, etc. can edit reports, including adding data related to pickups and/or deliveries a driver 114 neglected to record. In addition, repeated entries may be deleted or removed. In this manner, flexibility in reporting can be provided for any user of the animal tracking application.

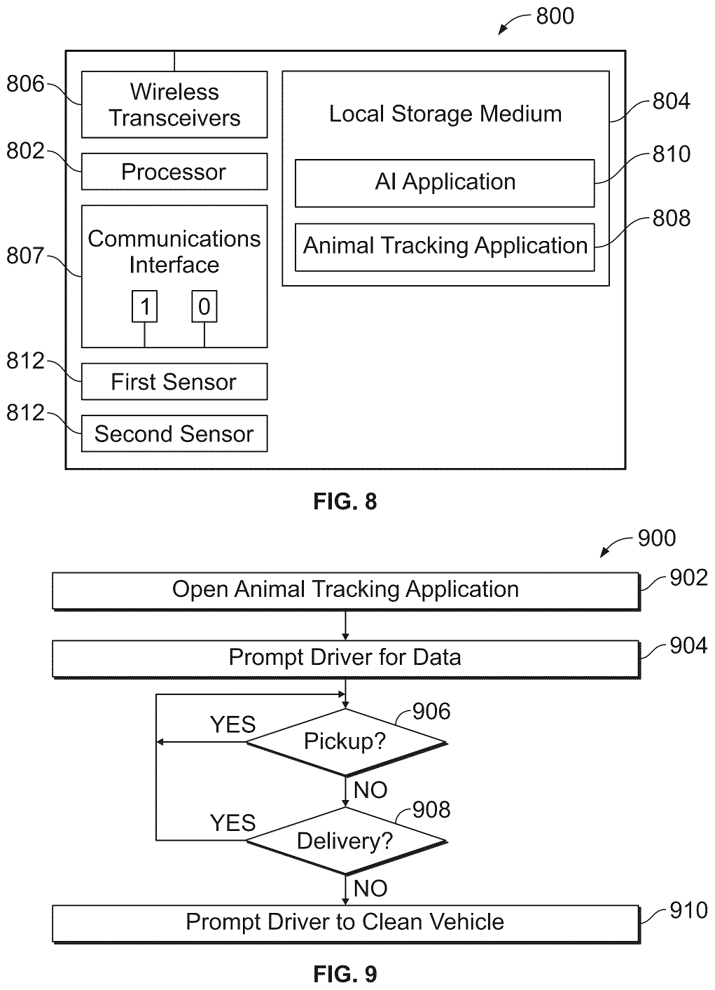

FIG. 8 illustrates a schematic diagram of an electronic device 800. In one example the electronic device 800 is the electronic device of FIG. 1. The electronic device 800 can house one or more processors 802 (e.g., a microprocessor, microcomputer, application-specific integrated circuit, etc.), a local storage medium 804 (e.g., memory), a transceiver 806, and output devices 807.

The local storage medium 804 can encompass one or more memory devices of any of a variety of forms (e.g., read only memory, random access memory, static random access memory, dynamic random access memory, etc.) and can be used by the one or more processors 802 to store and retrieve data. The data that is stored by the local storage medium 804 can include, but need not be limited to, user input information, animal tracking application information, operating system information, obtained data, informational data, etc. As used herein data and information can be utilized interchangeably. Each application includes executable code that can controls basic functions of an electronic device to which the electronic device 800 is electrically coupled, such as interaction among the various components, storage and retrieval of applications, etc.

The local storage medium 804 can include an animal tracking application 808 stored therein for dynamically tracking animals in real time. In one example, the animal tracking application can make determination utilized AI, including determinations such as when to communicate prompts to a driver, when a vehicle is as a location such as a pickup or drop off location, or the like. Alternatively, the local storage medium 804 can include an AI application 810 that communicates with the animal tracking application 808 to make these determinations accordingly.

The transceiver 806 can both transmit and receive communication. In one example the transceiver includes two separate components, an individual receiver and an individual transmitter. Alternatively, the transceiver is a single component that can both transmit and receive communications. In example embodiments the transceiver can provide communications over one or more methods, protocols or the like. Example methods, protocols, etc. include network-based communication, cellular communication, over-the-air communication, wireless communication, wired communication, Bluetooth communication, 3G, 4G, or 5G communication, telemetry-based communication, short-range communication, long-range communication, radio-based communication, Wi-Fi communication, satellite-based communication, or the like.

The animal tracking application 808 can allow for the real time and dynamically adjusted tracing of all production animal movement along with real time and dynamically adjusted reporting, analytics, and AI insights. Such driver data, animal data, cleaning data, vehicle data, or the like can be communicated to customers, employers, regulatory authorities, or the like as desired by a user. As a result, the tracing, the lockdown area (e.g., number of animals locked down/euthanized) can be dramatically reduced compared to when the animal tracking application 808 is not utilized. Such reduction in the lockdown area reduces the impact on the food supply and monetary impacts of producers.

In addition, the animal tracking application 808 provides custom features, such as different settings, prompts, input screens, etc. for different animals, producers, customers, etc. In addition, control is provided to the user of the animal tracking application 808 to provide the desired prompts to a driver. In this manner, the exact data desired by a user of the animal tracking application 808 is obtained. For example, data related to not just the animals, but also the feed being transported may be prompted. In addition, genetics information related to the animals transported, washing data, cleaning data, or the like can be provided. As a result, the animal tracking application can log such data and provide reports for a user accordingly when requested.

In one example, the animal tracking application 808 communicates with the electronic device so that an output device 807, such as a display screen of the electronic device provides an input screen that includes instructions, prompts, or the like for a user. By presenting the input screen with the prompts, information can be gathered related to the animals, cleanliness, feed, genetics, or the like that is not previously obtained. This information can then be utilized by a user to improve efficiencies, identify potentially infected animals during a disease outbreak, or the like. As a result the animal tracking application 808 improves the delivery process accordingly.

In addition, the electronic device 800 can include one or more sensors 814 that can detect data and information that can be utilized by the animal tracking application. For example, one of the sensors 812 can be a global navigation sensor that detects the location of the electronic device 800 and/or a vehicle in which the electronic device 800 resides. In another example, the sensor can monitor the operation of a vehicle to determine when a vehicle is operating, turned off, or the like that can be utilized by the animal tracking application to determine prompts to provide to a driver. For example, if a vehicle is turned off, this may indicate the vehicle is at a first stop, resulting in the animal tracking application 808 to provide a prompt for data related to the stop. Alternatively, a sensor may detect a vehicle is placed in neutral, or water is detected indicating a wash of the vehicle is occurring. Thus, a prompt is provided to the driver for washing information.

FIG. 9 illustrates a method of tracking animal movement 900 in accordance with this disclosure. In example embodiments, any of the electronic devices, animal tracking applications, input screens, or the like previously presented can accomplish the different steps of the method presented.

At 902, when a driver begins the animal movement, an animal tracking application is opened. In one example, the animal tracking application communicates with a movement sensor and automatically begins startup, or operation upon sensing movement of a vehicle. Alternatively, the driver manually actuates an electronic device, such as their smart phone, or a company issued electronic device to begin the operation of the animal tracking application.

At 904, one or more processors prompt the driver for data. The data can include driver data, vehicle data, route data, animal data, or the like. In one example, the driver may have a pre-loaded profile that can be automatically input into prompts to dynamically adjust the prompts with the data desired. In this manner, drive name, vehicle registration and license information, or the like can be automatically input into the prompts. In addition, the animal tracking application may determine in real time the date, and location of the vehicle, and automatically populate prompts accordingly.

At 906, one or more processors determine whether a driver is at a pickup. In one example, the animal tracking application communicates with a navigation system, such as a GPS to determine a pickup location has been reached in real time. In one example, the animal tracking application includes a lookup table that includes the names, addresses, locations, etc. of numerous pickup locations, and a navigation system name, address, location can be compared and matched to such pickup locations. Alternatively, the location can be manually input by a driver when a location is reached. The driver may be prompted to provide the information desired.

If at 906, a determination is made that the driver is at a pickup location the one or more processors communicate one or more prompts for data. In one example, data includes animal data such as the number of animals loaded. In addition to communicating the prompts, the one or more processors as continue to determine whether a driver is at a pickup location. In particular, after pickup, additional pickups may occur.

In addition to determining whether a driver is at a pickup location, in response to the determination, at 908 the one or more processors determine whether a drop off location has been reached. The animal tracking application can make determinations related to the drop off location in the same way as when a pickup location is determined. In particular, once animals have been picked up and are currently on the vehicle, determinations are continuously made in real time whether the vehicle has reached a new pickup, or a drop off location. Still, when no animals are determined to be on the vehicle, the animal tracking application only determines whether a pickup location has been reached to save battery life of the electronic device.

In response to determining a drop off location has been reached, the one or more processors can prompt the driver for data. The data can include animal data, driver data, vehicle data, or the like. In one example, animal data, including the number of animals dropped off is provided. In this manner, the animal tracking application can dynamically adjust data related to the animals, feed, etc. as pickups and drop offs occur. Such information can be logged, recorded, and reproduced or correlated for a report at a later time.

In response to determining that no more animals remain in a vehicle, at 900 the one or more processors communicate prompts to the driver for cleaning the vehicle. Such cleaning can include wash data, including date, time, type of wash, or the like. In this manner the wash data can also be logged for a report so that a user knows if a disease outbreak is discovered to occur in a load of animals that animals transported after the cleaning are not affected by such disease outbreak. As a result, the animal tracking application can in real time identify animals that have been loaded onto a vehicle, including dynamically adjusting data related to the animals, and provide reports associated with movements of the animals. In this manner the animal is quickly tracked between all locations.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer program product comprising a non-transitory computer readable storage medium comprising computer executable code to:
obtain at least one of driver data or vehicle data;
determine that a vehicle is at a first pickup location;
obtain animal data related to the first pickup location;
determine that the vehicle is at a first drop off location;
obtain additional animal data related to the first drop off location;
dynamically adjust the animal data to form adjusted animal data based on the additional animal data obtained; and
record in a memory the adjusted animal data.

2. The computer program product of claim 1, further comprising executable code to:
communicate the adjusted animal data to a remote electronic device in response to a request by the remote electronic device for the adjusted animal data.

3. The computer program product of claim 1, wherein to obtain the at least one of the driver data or the vehicle data, the executable code to communicate a prompt on an input screen of an electronic device for the driver data or the vehicle data.

4. The computer program product of claim 1, wherein to obtain the at least one of the driver data or the vehicle data, the executable code to automatically load a profile of a driver of a vehicle.

5. The computer program product of claim 1, wherein to determine that the vehicle is at the first pickup, the executable code to obtain location data from a sensor of the vehicle.

6. The computer program product of claim 1, wherein to determine that the vehicle is at the first pickup, the executable code to obtain location data from a manual input of a driver.

7. The computer program product of claim 1, further comprising executable code to continuously monitor a location of the vehicle in response to determining the first pickup location; and determine a second pickup location based on monitoring the location of the vehicle.

8. The computer program product of claim 7, wherein to determine the second pickup location comprises utilizing an artificial intelligence application.

9. The computer program product of claim 7, wherein in response to determining the second pickup location, the executable code to obtain additional animal data; and dynamically adjust the animal data based on the additional animal data.

10. The computer program product of claim 1, further comprising executable code to determine no animals remain in the vehicle after determining the vehicle is at the first pickup location; and obtain cleaning data related to the vehicle in response to determining that no animals remain in the vehicle.

11. The computer program product of claim 10, wherein to obtain the cleaning data the executable code to prompt a driver to enter wash data related to the vehicle.

12. The computer program product of claim 11, further comprising executable code to record the wash data in the memory.

13. A system for tracking animals comprising:
an electronic device having a memory to store executable instructions and one or more processors, when implementing the executable instructions, to:
obtain at least one of driver data or vehicle data;
determine that a vehicle is at a first pickup location;
obtain animal data related to the first pickup location;
determine that the vehicle is at a first drop off location;
obtain additional animal data related to the first drop off location;
dynamically adjust the animal data to form adjusted animal data based on the additional animal data obtained; and
record in a memory the adjusted animal data.

14. The system of claim 13, wherein the electronic device includes a sensor configured to obtain location data of the electronic device, and the one or more processors further configured to determine the first pickup location based on the location data.

15. The system of claim 13, wherein the electronic device includes an input screen, and the one or more processors are further configured to display a prompt for the animal data in response to determining the vehicle is at the first pickup location.

16. The system of claim 13, the one or more processors further configured to:
continuously monitor a location of the vehicle in response to determining the first pickup location; and
determine a second pickup location based on monitoring the location of the vehicle.

17. The system of claim 16, wherein to determine the second pickup location comprises utilizing an artificial intelligence application.

18. The system of claim 16, wherein in response to determining the second pickup location, the one or more processors further configured to:
obtain additional animal data; and
dynamically adjust the animal data based on the additional animal data.

19. A method for tracking animals, comprising:
under control of one or more processors including program instructions to:
obtain at least one of driver data or vehicle data;
determine that a vehicle is at a first pickup location;
obtain animal data related to the first pickup location;
determine that the vehicle is at a first drop off location;
obtain additional animal data related to the first drop off location;
dynamically adjust the animal data to form adjusted animal data based on the additional animal data obtained; and
record in a memory the adjusted animal data.

20. The method of claim 19, the one or more processors further configured to:
continuously monitor a location of the vehicle in response to determining the first pickup location; and
determine a second pickup location based on monitoring the location of the vehicle.
